(19) United States
(12) Patent Application Publication
(10) Pub. No.: US 2020/0410384 A1
(43) Pub. Date: Dec. 31, 2020

(54) HYBRID QUANTUM-CLASSICAL GENERATIVE MODELS FOR LEARNING DATA DISTRIBUTIONS

(71) Applicant: President and Fellows of Harvard College, Cambridge, MA (US)

(72) Inventors: Alan Aspuru-Guzik, Cambridge, MA (US); Yudong Cao, Cambridge, MA (US); Peter D. Johnson, Somerville, MA (US)

(21) Appl. No.: 17/017,102

(22) Filed: Sep. 10, 2020

Related U.S. Application Data
(63) Continuation of application No. PCT/US19/21582, filed on Mar. 11, 2019.
(60) Provisional application No. 62/641,371, filed on Mar. 11, 2018.
(60) Provisional application No. 62/683,276, filed on Jun. 11, 2018.

(51) Int. Cl. G06N 10/00; G06N 3/04; G06N 3/08; G06N 5/04; G06N 7/08

(52) U.S. Cl. CPC G06N 10/00; G06N 3/0454; G06N 7/08; G06N 5/046; G06N 3/084

(57) ABSTRACT

Hybrid quantum-classical generative models for learning data distributions are provided. In various embodiments, methods of and computer program products for operating a Helmholtz machine are provided. In various embodiments, methods of and computer program products for operating a generative adversarial network are provided. In various embodiments, methods of and computer program products for variational autoencoding are provided.

### CROSS-REFERENCE TO RELATED APPLICATIONS

This application is a continuation of International Application No. PCT/US19/21582, filed Mar. 11, 2019, which claims the benefit of U.S. Provisional Application Nos. 62/641,371, filed Mar. 11, 2018, and 62/683,276, filed Jun. 11, 2018, all of which are hereby incorporated by reference in their entireties.

### BACKGROUND

Embodiments of the present disclosure relate to generative modeling tasks, and more specifically, to hybrid quantum-classical generative models for learning data distributions including Helmholtz machines.

### BRIEF SUMMARY

According to embodiments of the present disclosure, hybrid quantum-classical generative models for learning data distributions are provided.

In various embodiments, methods of and computer program products for operating a Helmholtz machine is provided. A state is prepared with a quantum circuit by configuring the quantum circuit according to a plurality of configuration parameters. The state corresponds to a probability distribution. The state is sampled to provide a plurality of samples to an input layer of a first neural network. The first neural network is trained and the plurality of configuration parameters is tuned to generate data at an output layer of the first neural network, according to the probability distribution. The generated data is provided to a second neural network. The second neural network is trained to produce a distribution over variables from the generated data.

In some embodiments, the state is a quantum thermal state.

In some embodiments, tuning the plurality of configuration parameters comprises determining a gradient of an objective function. In some embodiments, tuning the plurality of configuration parameters further comprises performing gradient descent.

In some embodiments, the method includes alternating between: 1) training the first neural network and tuning the plurality of configuration parameters; and 2) training the second neural network.

In some embodiments, the first neural network comprises a feedforward neural network. In some embodiments, the first neural network comprises a Boltzmann machine. In some embodiments, the second neural network comprises a feedforward neural network. In some embodiments, the second neural network comprises a Boltzmann machine. In some embodiments, the first neural network comprises at least one hidden layer. In some embodiments, the second neural network comprises at least one hidden layer.

In various embodiments, methods of and computer program products for operating a Helmholtz machine is provided. A state is prepared with a quantum circuit. The state corresponds to a probability distribution. The state is sampled to provide a plurality of samples to an input layer of a first neural network. The first neural network is trained to generate data at an output layer of the first neural network, according to the probability distribution. The generated is provided data to a second neural network. The second neural network is trained to produce a distribution over variables from the generated data.

In some embodiments, the state is a quantum thermal state.

In some embodiments, preparing the state comprises configuring the quantum circuit according to a plurality of configuration parameters. In some embodiments, preparing the state comprises tuning the plurality of configuration parameters. In some embodiments, tuning the plurality of configuration parameters comprises determining a gradient of an objective function. In some embodiments, tuning the plurality of configuration parameters further comprises performing gradient descent.

In some embodiments, the method includes alternately training the first and second neural networks.

In some embodiments, the first neural network comprises a feedforward neural network. In some embodiments, the first neural network comprises a Boltzmann machine. In some embodiments, the second neural network comprises a feedforward neural network. In some embodiments, the second neural network comprises a Boltzmann machine. In some embodiments, the first neural network comprises at least one hidden layer. In some embodiments, the second neural network comprises at least one hidden layer.

In various embodiments, methods of and computer program products for operating a generative adversarial network is provided. A state is prepared with a quantum circuit by configuring the quantum circuit according to a plurality of configuration parameters. The state corresponds to a probability distribution. The state is sampled to provide a plurality of samples to an input layer of a first neural network. The first neural network is trained and the plurality of configuration parameters is tuned to generate data at an output layer of the first neural network according to the probability distribution. The data is provided to a second neural network. The second neural network is trained to distinguish between the generated data and sample data.

In some embodiments, the state is a quantum thermal state.

In some embodiments, tuning the plurality of configuration parameters comprises determining a gradient of an objective function. In some embodiments, tuning the plurality of configuration parameters further comprises performing gradient descent.

In some embodiments, the method includes alternating between: 1) training the first neural network and tuning the plurality of configuration parameters; and 2) training the second neural network.

In some embodiments, the first neural network comprises a feedforward neural network. In some embodiments, the first neural network comprises a Boltzmann machine. In some embodiments, the second neural network comprises a feedforward neural network. In some embodiments, the second neural network comprises a Boltzmann machine. In some embodiments, the first neural network comprises at least one hidden layer. In some embodiments, the second neural network comprises at least one hidden layer.

In various embodiments, methods of and computer program products for operating a generative adversarial network is provided. A state is prepared with a quantum circuit. The state corresponds to a probability distribution. The state is sampled to provide a plurality of samples to an input layer of a first neural network. The first neural network is trained to generate data at an output layer of the first neural network according to the probability distribution. The data is provided to a second neural network. The second neural network is trained to distinguish between the generated data and sample data.

In some embodiments, the state is a quantum thermal state.

In some embodiments, preparing the state comprises configuring the quantum circuit according to a plurality of configuration parameters. In some embodiments, preparing the state comprises tuning the plurality of configuration parameters. In some embodiments, tuning the plurality of configuration parameters comprises determining a gradient of an objective function. In some embodiments, tuning the plurality of configuration parameters further comprises performing gradient descent.

In some embodiments, the method includes alternately training the first and second neural networks.

In some embodiments, the first neural network comprises a feedforward neural network. In some embodiments, the first neural network comprises a Boltzmann machine. In some embodiments, the second neural network comprises a feedforward neural network. In some embodiments, the second neural network comprises a Boltzmann machine. In some embodiments, the first neural network comprises at least one hidden layer. In some embodiments, the second neural network comprises at least one hidden layer.

In various embodiments, methods of and computer program products for variational autoencoding is provided. A state is prepared with a quantum circuit by configuring the quantum circuit according to a plurality of configuration parameters. The state corresponds to a probability distribution. The state is sampled to provide a plurality of samples to an input layer of a first neural network. The first neural network is trained to generate data at an output layer of the first neural network, according to the probability distribution. The plurality of configuration parameters is tuned based on the generated data.

In some embodiments, the state is a quantum thermal state.

In some embodiments, the method includes alternately training the first neural network and tuning the plurality of configuration parameters.

In some embodiments, tuning the plurality of configuration parameters comprises determining a gradient of an objective function. In some embodiments, tuning the plurality of configuration parameters further comprises performing gradient descent.

In some embodiments, the first neural network comprises a feedforward neural network. In some embodiments, the first neural network comprises a Boltzmann machine. In some embodiments, the first neural network comprises at least one hidden layer.

### BRIEF DESCRIPTION OF THE SEVERAL VIEWS OF THE DRAWINGS

FIG. 1 is a schematic view of a hybrid quantum-classical Helmholtz machine according to embodiments of the present disclosure.

FIG. 2 is a schematic view of a hybrid quantum-classical generative adversarial network (GAN) according to embodiments of the present disclosure.

FIG. 3 is a schematic view of a hybrid quantum-classical variational autoencoder according to embodiments of the present disclosure.

FIG. 4 is a flowchart illustrating a method of operating a Helmholtz machine according to embodiments of the present disclosure.

FIG. 5 is a flowchart illustrating a method of operating a generative adversarial network (GAN) according to embodiments of the present disclosure.

FIG. 6 is a flowchart illustrating a method of operating a variational autoencoder according to embodiments of the present disclosure.

FIG. 7 depicts a computing node according to embodiments of the present disclosure.

### DETAILED DESCRIPTION

The present disclosure addresses the use of near-term quantum computers for assisting generative modeling tasks in classical machine learning. Since near-term quantum information processors (for instance devices of around 50 qubits) can produce statistical patterns that are computationally difficult for a classical computer to produce, they may be used for efficiently generating data samples that cannot be efficiently generated on classical computers. Schemes are provided herein that use only low-depth quantum circuits for the relevant generative tasks in each scheme.

Artificial neural networks (ANNs) are distributed computing systems, which consist of a number of neurons interconnected through connection points called synapses. Each synapse encodes the strength of the connection between the output of one neuron and the input of another. The output of each neuron is determined by the aggregate input received from other neurons that are connected to it. Thus, the output of a given neuron is based on the outputs of connected neurons from preceding layers and the strength of the connections as determined by the synaptic weights. An ANN is trained to solve a specific problem (e.g., pattern recognition) by adjusting the weights of the synapses such that a particular class of inputs produce a desired output.

Various algorithms may be used for this learning process. Certain algorithms may be suitable for specific tasks such as image recognition, speech recognition, or language processing. Training algorithms lead to a pattern of synaptic weights that, during the learning process, converges toward an optimal solution of the given problem. Backpropagation is one suitable algorithm for supervised learning, in which a known correct output is available during the learning process. The goal of such learning is to obtain a system that generalizes to data that were not available during training.

In general, during backpropagation, the output of the network is compared to the known correct output. An n error value is calculated for each of the neurons in the output layer. The error values are propagated backwards, starting from the output layer, to determine an error value associated with each neuron. The error values correspond to each neuron's contribution to the network output. The error values are then used to update the weights. By incremental correction in this way, the network output is adjusted to conform to the training data.

When applying backpropagation, an ANN rapidly attains a high accuracy on most of the examples in a training-set. The vast majority of training time is spent trying to further increase this test accuracy. During this time, a large number of the training data examples lead to little correction, since the system has already learned to recognize those examples. While in general, ANN performance tends to improve with the size of the data set, this can be explained by the fact that larger data-sets contain more borderline examples between the different classes on which the ANN is being trained.

Suitable artificial neural networks include but are not limited to a feedforward neural network, a radial basis function network, a self-organizing map, learning vector quantization, a recurrent neural network, a Hopfield network, a Boltzmann machine, an echo state network, long short term memory, a bi-directional recurrent neural network, a hierarchical recurrent neural network, a stochastic neural network, a modular neural network, an associative neural network, a deep neural network, a deep belief network, a convolutional neural networks, a convolutional deep belief network, a large memory storage and retrieval neural network, a deep Boltzmann machine, a deep stacking network, a tensor deep stacking network, a spike and slab restricted Boltzmann machine, a compound hierarchical-deep model, a deep coding network, a multilayer kernel machine, or a deep Q-network.

A Helmholtz machine is a type of artificial neural network that accounts for the hidden structure of a set of data by being trained to create a generative model of the original set of data. By learning economical representations of the data, the underlying structure of the generative model should approximate the hidden structure of the data set. A Helmholtz machine contains two networks, a bottom-up recognition network that takes the data as input and produces a distribution over hidden variables, and a top-down generative network that generates values of the hidden variables and the data itself.

A Helmholtz machine may be trained using an unsupervised learning algorithm, such as the wake-sleep algorithm. In the wake-sleep algorithm, training consists of two phases. In the wake phase, neurons are fired by recognition connections from inputs to outputs. Generative connections leading from outputs to inputs are then modified to increase probability that they would recreate the correct activity in the layer below. In the sleep phase, neurons are fired by generative connections while recognition connections are being modified to increase probability that they would recreate the correct activity in the layer above.

Generative adversarial networks (GANs) are systems of two neural networks contesting with each other in a zero-sum game framework. One network generates candidates and the other evaluates them. The generative network learns to map from a latent space to a particular data distribution of interest, while the discriminative network discriminates between instances from the true data distribution and candidates produced by the generator. The generative network's training objective is to increase the error rate of the discriminative network. In this way, it is trained to produce novel synthesized data that appear to have come from the true data distribution.

A known dataset may serve as the initial training data for the discriminator. Training the discriminator involves presenting it with samples from the dataset until it reaches some level of accuracy. The generator may be seeded with a randomized input that is sampled from a predefined latent space (e.g., a multivariate normal distribution). Thereafter, samples synthesized by the generator are evaluated by the discriminator. Backpropagation may be applied in both networks so that the generator produces better data (e.g., images), while the discriminator becomes more skilled at flagging synthetic images. In various embodiments, the generator is a deconvolutional neural network and the discriminator is a convolutional neural network.

An autoencoder is a neural network that learns to compress data from the input layer into a short code, and then uncompress that code into something that closely matches the original data. This forces the autoencoder to engage in dimensionality reduction, for example by learning how to ignore noise. Autoencoders are also useful as generative models.

As used herein, a quantum gate (or quantum logic gate) is a basic quantum circuit operating on a small number of qubits. By analogy to classical computing, quantum gates form quantum circuits, like classical logic gates form conventional digital circuits. Quantum logic gates are represented by unitary matrices. Various common quantum gates operate on spaces of one or two qubits, like classical logic gates operate on one or two bits. As matrices, quantum gates can be described by 2ⁿ×2ⁿ sized unitary matrices, where n is the number of qubits. The variables that the gates act upon, the quantum states, are vectors in 2ⁿ complex dimensions. The base vectors indicate the possible outcomes if measured, and a quantum state is a linear combinations of these outcomes. The action of the gate on a specific quantum state is found by multiplying the vector which represents the state by the matrix representing the gate. Accordingly, a given quantum state may be prepared on a quantum circuit through application of a plurality of gates. A given state may be characterized as a distribution function that provides a distribution describing a continuous random variable.

Various physical embodiments of a quantum computer are suitable for use according to the present disclosure. In general, the fundamental data storage unit in quantum computing is the quantum bit, or qubit. The qubit is a quantum-computing analog of a classical digital-computer-system bit. A classical bit is considered to occupy, at any given point in time, one of two possible states corresponding to the binary digits 0 or 1. By contrast, a qubit is implemented in hardware by a physical component with quantum-mechanical characteristics. Each unit has an infinite number of different potential quantum-mechanical states. When the state of a qubit is physically measured, the measurement produces one of two different basis states. Thus, a single qubit can represent a one, a zero, or any quantum superposition of those two qubit states; a pair of qubits can be in any quantum superposition of 4 states; and three qubits in any superposition of 8 states. While qubits are characterized herein as mathematical objects, each corresponds to a physical qubit that can be implemented using a number of different physical implementations, such as trapped ions, optical cavities, individual elementary particles, molecules, or aggregations of molecules that exhibit qubit behavior.

In contrast to classical gates, there are an infinite number of possible single-qubit quantum gates that change the state vector of a qubit. Changing the state of a qubit state vector is therefore referred to as a rotation. A rotation, state change, or single-qubit quantum-gate operation may be represented mathematically by a unitary 2×2 matrix with complex elements.

A quantum circuit can be specified as a sequence of quantum gates. To conceptualize a quantum circuit, the matrices corresponding to the component quantum gates may be multiplied together in the order specified by the symbol sequence to produce a 2×2 complex matrix representing the same overall state change. A quantum circuit may thus be expressed as a single resultant operator. However, designing a quantum circuit in terms of constituent gates allows the design to conform to standard sets of gates, and thus enable greater ease of deployment. A quantum circuit thus corresponds to a design for a physical circuit in a quantum computer.

The quantum gates making up a quantum circuit may have an associated plurality of tuning parameters. For example, in embodiments based on optical switching, tuning parameters may correspond to the angles of individual optical elements.

Hybrid Quantum-Classical Helmholtz Machine

The present disclosure provides for using quantum computers to assist the realization of a Helmholtz machine. A quantum-assisted Helmholtz machine for capturing industry dataset can be realized on quantum annealers. However, the performance is limited by the restricted connectivity of the device as well as limitations in the form of interaction in the Hamiltonian (quantum annealers only realize two-body Ising interactions). These limitations are overcome by 1) taking advantage of the general connectivity of a quantum computer and 2) using a variational quantum circuit to produce a quantum state that depends on the circuit parameters. The quantum state may be represented by a probability distribution over hangdescribed by a density operator on the Hilbert space H describing the quantum system.

One example of a quantum state is an approximate thermal state of a quantum Hamiltonian (Hamiltonians with interactions beyond those in the classical Ising model). In general, a quantum system in thermal equilibrium is typically characterized by T, the temperature of the system, and H, the Hamiltonian of the system. The density operator describing the state of this equilibrium quantum system is

$$ρ = \frac{{e}^{- H \text{/} T}}{Z}$$

and is known as the quantum thermal state or Gibbs state. This is obtained mathematically as the density operator which maximizes the entropy of the system, consistent with the average energy of the system being a fixed value. Quantum thermal states are useful in this context in that they afford an efficient estimate of a lower bound on the KL divergence, which is used for parameter training as set out below.

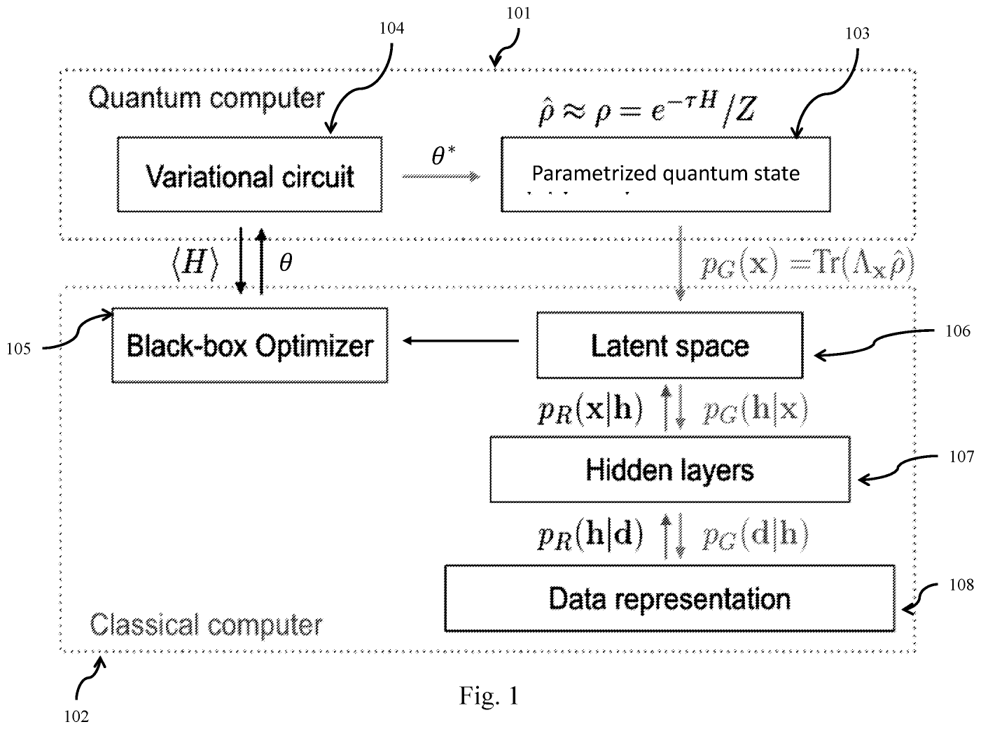

An overview of the hybrid scheme is shown in FIG. 1.

FIG. 1 is a schematic of a hybrid quantum-classical Helmholtz machine according to embodiments of the present disclosure. The down arrows (between 103, 106, 107, 108) show the flow of conditional dependence for the generative distribution p_{G} (d) and the up arrows (between 108, 107, 106) represent the flow of conditional dependence for recognition distribution p_{R}(d).

A quantum computer 101 is used to variationally prepare quantum state 103, which may be an approximation of the thermal state of some Hamiltonian H as described above. Low-depth circuits can be trained to approximate the thermal state of Ising Hamiltonians. This technique can be extended to quantum Hamiltonians with possibly non-diagonal couplings, and heuristics may be used for efficiently training thermal states of quantum Hamiltonians for capturing a given data distribution.

In various embodiments, quantum computer 101 includes a variational circuit 104. A given variational quantum circuit may be parameterized in a suitable device-specific manner. More generally, the quantum gates making up a quantum circuit may have an associated plurality of tuning parameters. For example, in embodiments based on optical switching, tuning parameters may correspond to the angles of individual optical elements.

In various embodiments, black-box optimizer 105 is implemented in classical computing node 102. The variational parameters θ are iteratively improved by measuring an objective function and then using a classical optimization routine to suggest new parameters. In various embodiments, the objective function is a sum of contributions from both quantum and classical components. In such embodiments, the quantum circuit parameters and classical neural network parameters are tuned in an alternating pattern to optimize the objective function. In various embodiments, the quantum circuit parameters are tuned by determining a gradient. In various embodiments, the quantum circuit parameters are tuned by gradient descent. However, it will be appreciated that a variety of mathematical optimization methods may be applied.

After an approximate thermal state \hat{p} 103 is prepared, one is able to use the state as a generative model in the latent space 106 by sampling from it. The distribution p_{G}(x)=Tr(Λₓ\hat{p}) of samples x in the latent space 106 originates the generative distribution. Here Λₓ corresponds to an element of a POVM. After measurement outcome x is obtained, one then proceeds to implement the generative distribution from the latent space 106 to the hidden layer(s) 107 p_{G}(h|x) and that from the hidden layer(s) 107 to the data layer 108 p_{G}(d|h) by using a probabilistic neural network (such as a restricted Boltzmann machine).

Apart from the generative distribution p_{G} another element of the Helmholtz machine is the recognition distribution p_{R},which is a probabilistic neural network (such as a restricted Boltzmann machine) that can be trained and implemented in a purely classical manner. The training of the entire network consists of adjusting the parameters of the generative and recognition distributions in an alternating fashion, a procedure called the wake-sleep algorithm. As set out herein, classical restricted Boltzmann machines can be used to compress a dataset in high dimensions to a latent space whose dimension is low enough for an implementation on a near-term quantum device, and use the quantum device as a sampler in the latent space to generate new data points based on the given set of data.

In various embodiments, training is performed in an alternating manner between the generator and recognition network. In some embodiments, feedback from the classical components is provided to optimizer 105 to enable further optimization of parameters θ.

Hybrid Quantum-Classical Generative Adversarial Network (GAN)

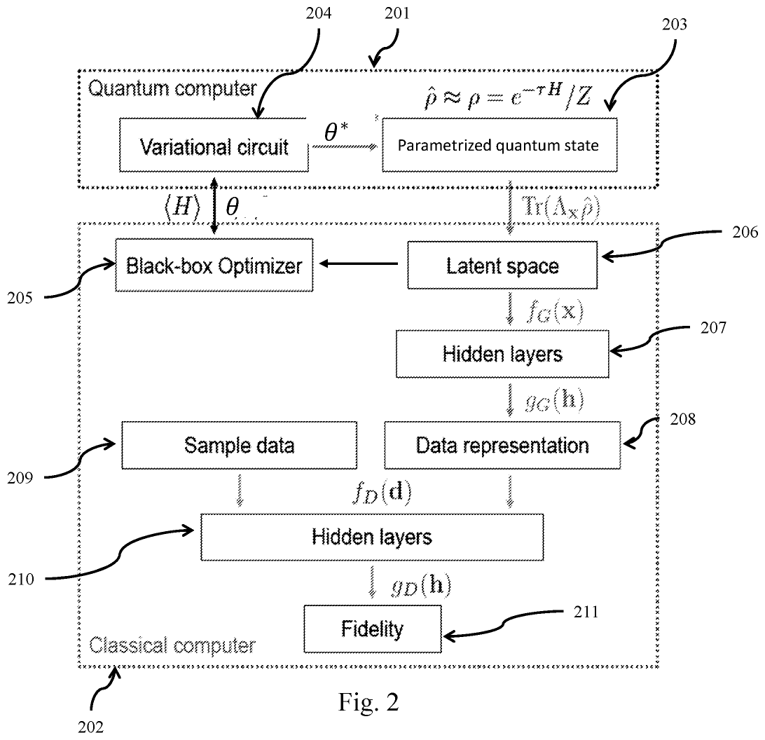

The present disclosure provides for using quantum computers for generative adversarial networks (GAN), as described in FIG. 2.

FIG. 2 is a schematic of a hybrid quantum-classical generative adversarial network (GAN). The arrows from thermal state 203 down to data representation 208 show the flow of variable dependence for the generator G(x)=g_{G}∘f_{G}(x) and the arrows from data representation 208 down to fidelity 211 represent the flow of variable dependence for the discriminator D(d)=g_{D}∘f_{D}(d). Here the parallel arrows from sample data 209 and data representation 208 to hidden layers 210 of the discriminator is not meant as using the two data spaces as two separate input variables to D, but rather means that during training both the sample data 209 and the generated data are combined into one set and each time either a sample data or a generated data is fed to the discriminator.

As in the embodiment of FIG. 1, quantum computer 201 includes a variational circuit 204. A given variational quantum circuit may be parameterized in a suitable device-specific manner. More generally, the quantum gates making up a quantum circuit may have an associated plurality of tuning parameters. For example, in embodiments based on optical switching, tuning parameters may correspond to the angles of individual optical elements.

In various embodiments, black-box optimizer 205 is implemented in classical computing node 202. The variational parameters θ are iteratively improved by measuring an objective function and then using a classical optimization routine to suggest new parameters. In various embodiments, the objective function is a sum of contributions from both quantum and classical components. In such embodiments, the quantum circuit parameters and classical neural network parameters are tuned in an alternating pattern to optimize the objective function. In various embodiments, the quantum circuit parameters are tuned by determining a gradient. In various embodiments, the quantum circuit parameters are tuned by gradient descent. However, it will be appreciated that a variety of mathematical optimization methods may be applied.

Accordingly, the present disclosure enables assisting the realization of GANs by taking advantage of quantum computers. Similar to the Helmholtz machine, the ability of low-depth quantum circuits to prepare a parametrized quantum state (such as a thermal state) is used for realizing the generative model. In the classical case this corresponds to the noise space. Instead of starting from random noise, sampling is from the quantum state generated by the variational circuit. The remainder of GAN proceeds entirely classically: the samples are mapped to the data space by a generator network implemented on the classical computer, and the discriminator is used to decide whether the data generated is authentic.

In various embodiments, training is performed in an alternating manner between the generator and discriminator. In some embodiments, feedback from the classical components is provided to optimizer 205 to enable further optimization of parameters θ.

Hybrid Quantum-Classical Variational Autoencoder (VAE)

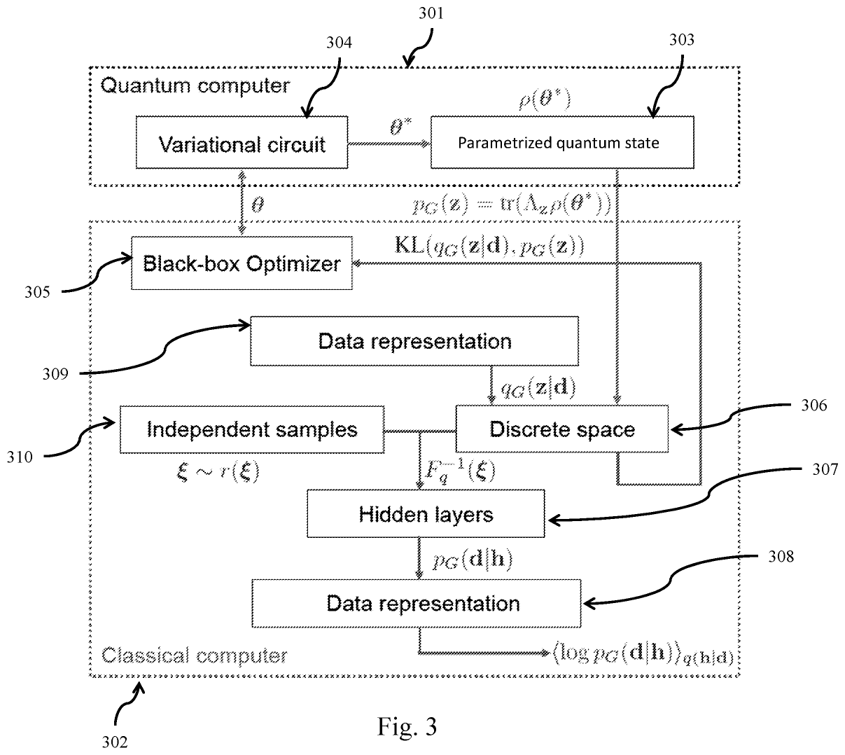

FIG. 3 is a schematic of a hybrid quantum-classical variational autoencoder according to embodiments of the present disclosure. In this example, a general case is illustrated, in which quantum computer 301 variationally generates a state 303 (not necessarily an approximate thermal state). The same generalization applies to both the hybrid quantum-classical Helmholtz machine and hybrid GAN described above.

As in the embodiment of FIG. 1, quantum computer 301 includes a variational circuit 304. A given variational quantum circuit may be parameterized in a suitable device-specific manner. More generally, the quantum gates making up a quantum circuit may have an associated plurality of tuning parameters. For example, in embodiments based on optical switching, tuning parameters may correspond to the angles of individual optical elements.

In various embodiments, black-box optimizer 305 is implemented in classical computing node 302. The variational parameters θ are iteratively improved by measuring an objective function and then using a classical optimization routine to suggest new parameters.

The present disclosure provides a hybrid quantum-classical scheme for realizing variational autoencoders (VAE). VAE is an effective technique for training generative models for capturing a data distribution using a continuous latent space. VAE constructions with discrete latent space are possible. Accordingly, discrete VAE using thermal states of transversal Ising Hamiltonians are also possible. However, such approaches train only the diagonal (classical) part of the Hamiltonian while keeping the transverse field constant. The present disclosure provides a more general scheme where the (approximate) parametrized state 303, prepared by a variational circuit 304, is used for drawing samples in the latent space. The construction is similar in spirit to the Helmholtz machine, where in the classical construction of classical discrete VAE, the source of randomness is replaced with samples drawn from a quantum state which is approximately e^{-βH}/Z for some general quantum Hamiltonian H, inverse temperature β and partition function Z.

In various embodiments, the Helmholtz machine or GAN may entail approximate thermal state preparation, as described below. The basic idea of approximately preparing a thermal state (103, 203, 303) under an n-qubit Hamiltonian H is to start from the thermal state that is relatively easy to prepare (for example consider ρ₀=e^{-τHx}/Z of a 1-local Hamiltonian H_{X}=Σᵢ₌₁ⁿXᵢ with inverse temperature τ and partition function Z) and evolve the state ρ₀ in a way that approximates an adiabatic evolution from H_{X} to some Hamiltonian H whose thermal state is harder to sample from. The evolution is realized using a parametrized circuit (104, 204, 304) U(γ, β) which is similar to a Quantum Approximate Optimization Algorithm (QAOA) circuit, where the parameters γ and β describe an annealing schedule. The parameters are then optimized such that the energy of the final state U(γ, β) ρ₀U(γ, β)^{†} with respect to the Hamiltonian H is minimized. The optimized parameters γ* and β* then provide a recipe for approximately preparing the thermal state (103, 203, 303) \hat{p}=U(γ*, β* )ρ₀U(γ*, β*)^{†}. The ability to sample from \hat{p} is used as part of the generative model for the Helmholtz machine, as described below.

In various embodiments, a quantum-classical Helmholtz machine is provided. For a given set of data d∈{0,1}ⁿ following a distribution p(d), the goal is to train a generative model G which produces a distribution p_{G} (d) over n-bit strings, such that p_{G} is as close to p as possible. The generative model is realized using a layered neural network that samples from the probability distribution p_{G} of n-bit outputs. One formal measure of this difference is the KL divergence of p with respect to p_{G}. The network consists of a top layer x representing the latent space 106, layers 107 of hidden neurons h and the output layer 108 of size n. Minimizing the KL divergence by varying p_{G} is equivalent to maximizing the log likelihood of the generative model of Equation 1.

$$ℒ = {\sum }_{d} p ( d ) log {p}_{G} ( d ) \qquad Equation 1$$

In general, maximizing [symbol] in the space of G is hard. The essential technique of Helmholtz machines is to approximate p_{G}(h, x|d) with another distribution p_{R}(h, x|d). For convenience, h and x are referred to collectively as the explanations e for the data point d. Hence, instead of [symbol] a lower bound of the likelihood function is maximized. From the non-negativity of KL divergence from p_{R} to p_{G} (as discussed with regard to Equation 22, below), Equation 2 may be derived.

$$log {p}_{G} ( d ) \geq {\sum }_{e} {p}_{R} ( e \vert d ) log \frac{{p}_{G} ( e , d )}{{p}_{R} ( e \vert d )} \qquad Equation 2$$

Focusing on the term that is dependent on G, it may be expanded as in Equation 3.

log p_{G}(e, d)=log p_{G}(d|h)p_{G}(h|x)+log p_{G}(x) Equation 3

The first term is implemented classically and the second term is approximately Tr(Λₓρ) where Λₓ are positive-operator valued measure (POVM) elements each corresponding to a classical measurement outcome x. Putting together Equation 1, Equation 2, and Equation 3, a lower bound for the log likelihood of the generative model may be given as in Equation 4.

$${\sum }_{e , d} p ( d ) {p}_{R} ( e \vert d ) [ log {p}_{G} ( d \vert h ) {p}_{G} ( h \vert x ) + log Tr ( {Λ}_{x} \hat{ρ} ) ] \qquad Equation 4$$

Equation 4 omits terms that are independent of the generative distribution, since they vanish upon taking the derivative with respect to the parameters of the generative distribution. Rules are derived for tuning the parameters of the quantum Hamiltonian H, assuming that the thermal state preparation procedure is exact, namely \hat{p}=ρ=e^{-τHx}/Z. As an example, assume H is a 2-local Hamiltonian as in Equation 5.

$$H = {\sum }_{i} {h}_{i} {Z}_{i} + {\sum }_{i} {δ}_{i} {X}_{i} + {\sum }_{i \neq j} {J}_{ij} {Z}_{i} {Z}_{j} + {\sum }_{i \neq j} {K}_{ij} {X}_{i} {X}_{j} \qquad Equation 5$$

To maximize the bound in Equation 4 is to take its derivative with respect to individual coupling coefficients {hᵢ,δᵢ, Jᵢⱼ, Kᵢⱼ}. An approximation for log Tr(Λₓ\hat{p}) may be made with another lower bound, as in Equation 6.

$$\begin{matrix}log TR ( {Λ}_{x} ρ ) \geq log ( \frac{Tr ( {e}^{- τ H + log {Λ}_{x}} )}{Tr ( {e}^{- τ H} )} ) \\ = log Tr ( {e}^{- τ H + log {Λ}_{x}} ) - log Tr ( {e}^{- τ H} )\end{matrix} \qquad Equation 6$$

Combining lower bound of Equation 6 with the bound in Equation 4, a final lower bound for the log likelihood is given as in Equation 7.

$$\tilde{ℒ} = {\sum }_{e , d} p ( d ) {p}_{R} ( e \vert d ) [ log {p}_{G} ( d \vert h ) {p}_{G} ( h \vert x ) + log Tr ( {e}^{- τ H + log {Λ}_{x}} ) - log Tr ( {e}^{- τ H} ) ] + {\sum }_{d} p ( d ) {p}_{R} ( e \vert d ) log p ( e \vert d ) . \qquad Equation 7$$

For the Hamiltonian in Equation 5, taking derivative of [symbol] with respect to the coupling coefficients yields Equation 8.

$$\begin{matrix}\frac{\partial \tilde{ℒ}}{\partial {h}_{i}} = {\sum }_{e , d} p ( d ) {p}_{R} ( e \vert d ) [ \frac{Tr ( {e}^{- τ H + log {Λ}_{x}} \frac{\partial }{\partial {h}_{i}} H )}{Tr ( {e}^{- τ H + log {Λ}_{x}} )} - \\ \frac{Tr ( {e}^{- τ H} \frac{\partial }{\partial {h}_{i}} H )}{Tr ( {e}^{- τ H} )} ] \\ = {\sum }_{e , d} p ( d ) {p}_{R} ( e \vert d ) [ {〈 {Z}_{i} 〉}_{{ρ}_{x}} - {〈 {Z}_{i} 〉}_{ρ} ] \\ = {〈 {Z}_{i} 〉}_{{ρ}_{x} , R} - {〈 {Z}_{i} 〉}_{ρ , R} .\end{matrix} \qquad Equation 8$$

Here ρₓ=e^{-τH+log Λ}^{ₓ}/Tr(e^{-τH+log Λ}^{ₓ}) is the thermal state under the equivalent Hamiltonian H−log Λₓ. The notations [symbol] _{ρ}_{ₓ} and [symbol] _{ρ} represent expectation of measurement operators with respect to ρₓ and ρ. The subscript R stands for averaging over the recognition distribution. Similar expressions for gradients can be found as in Equation 9.

$$\frac{\partial \tilde{ℒ}}{\partial {δ}_{i}} = {〈 {X}_{i} 〉}_{{ρ}_{x} , R} - {〈 {X}_{i} 〉}_{ρ , R} \\ \frac{\partial \tilde{ℒ}}{\partial {J}_{ij}} = {〈 {Z}_{i} {Z}_{j} 〉}_{{ρ}_{x} , R} - {〈 {Z}_{i} {Z}_{j} 〉}_{ρ , R} \\ \frac{\partial \tilde{ℒ}}{\partial {K}_{ij}} = {〈 {X}_{i} {X}_{j} 〉}_{{ρ}_{x} , R} - {〈 {X}_{i} {X}_{j} 〉}_{ρ , R} \qquad Equation 9$$

In training the quantum state, the gradients above are evaluated by using the method described above to prepare the states ρₓ and ρ and measuring the relevant quantities.

The training of the remainder of the Helmholtz machine, which includes the recognition distribution and the part of the generative distribution that generates new data points from the latent space, is implemented as in a classical Helmholtz machine.

In various embodiments, hybrid quantum-classical generative adversarial networks (GANs) are provided. For a given data distribution p(d), a generator G(x) is trained to capture the data distribution as closely as possible. In particular, G (x)=g_{G}∘f_{G}(x) where x is the latent space 206 vector sampled from the distribution p_{G}(x)=Tr(\hat{p}Λₓ) and f_{G}, g_{G} are deterministic functions implemented by classical neural networks. In the classical case x is the noise vector that serves as a simple source of randomness. Here, x is generated with an efficiently tunable quantum state (203).

Unlike the Helmholtz machine, which uses the recognition distribution to help guide the training for the generator, here a discriminator D is used to try to tell samples from p(d) apart from the samples generated by G. The objective of the discriminator is therefore two-fold: 1) to be able to recognize an authentic sample as much as possible; 2) to be able to deny a generated sample as much as possible. The former translates to maximizing the log likelihood in Equation 10 and the latter translates to minimizing the log likelihood Σₓp_{G}(x) log D (G (x)) or equivalently maximizing Equation 11.

$$\begin{matrix}{\sum }_{d} p ( d ) log D ( d ) & Equation 10 \\ {\sum }_{x} {p}_{G} ( x ) log [ 1 - D ( G ( x ) ) ] & Equation 11\end{matrix}$$

Putting these together, the training goal for the discriminator D may be given as in Equation 12.

$${max}_{D} \underbrace{{\sum }_{d} p ( d ) log D ( d ) + {\sum }_{x} {p}_{G} ( x ) log [ 1 - D ( G ( x ) ) ]}_{V ( G , D )} \qquad Equation 12$$

The generator would like to work against such goal, ideally making D(d)=1/2 for all d. Hence, the joint objective of training the GAN may be phrased as in Equation 13.

$${min }_{G} {max}_{D} V ( G , D ) \qquad Equation 13$$

To accomplish such min-max training, various methods herein alternate between training the generator and the discriminator. The generator may be trained as described above, while the discriminator may be trained using any of a variety of techniques suitable for classical neural networks.

In various embodiments, a quantum-classical variational autoencoder is provided, which operates on a similar principle to the Helmholtz machine described above. For a given set of data d with distribution p_{D}(d), the goal of a variational autoencoder is also to train a generative model p_{G}(d) to maximize the log likelihood Σ_{d}p_{DG}(d) log p_{G}(d). To learn the distribution, a latent space h is introduced that extracts high-level features of the data set. For a given latent space, there is a prior distribution p_{G}(h). New data points can be generated by sampling from the joint distribution p_{G}(h, d)=p_{G}(d|h)p_{G}(h). However, the posterior distribution p_{G}(h|d) is often intractable to sample, since p_{G}(h|d)≈0 for most h. Therefore, approximate distribution q_{G} (h|d) is introduced, which is tractable to sample from. The quality of approximation is given by the KL divergence in Equation 14.

$$\begin{matrix}KL ( {q}_{G} ( h \vert d ) , {p}_{G} ( h \vert d ) ) = {〈 log \frac{{q}_{G} ( h \vert d )}{{p}_{G} ( h \vert d )} 〉}_{{q}_{G} ( h \vert d )} \\ = {〈 log \frac{{q}_{G} ( h \vert d )}{{p}_{G} ( h \vert d )} 〉}_{{q}_{G} ( h \vert d )} + log {p}_{G} ( d )\end{matrix} \qquad Equation 14$$

Rearranging the terms in Equation 14 yields the identity in Equation 15.

$$- log {p}_{G} ( d ) + KL ( {q}_{G} ( h \vert d ) , {p}_{G} ( h \vert d ) ) = {〈 log \frac{{q}_{G} ( h \vert d )}{{p}_{G} ( h , d )} 〉}_{{q}_{G} ( h \vert d )} \qquad Equation 15$$

Minimizing the left hand side will yield the dual goal of maximizing the log likelihood and finding q_{G}(h|d), a good approximation of the posterior p_{G}(h|d). With the equality in Equation 15, such minimization can be accomplished by minimizing the right hand side, which is tractable due to the tractability of q_{G}.

Up until this point, the mathematical formulations provided for both Helmholtz machines and variational autoencoders are identical. What differs in the two schemes is the method for treating the right hand side of Equation 15.

In the case of a Helmholtz machine, during the wake phase q_{G} is fixed, which is the recognition distribution, and p_{G} is trained to minimize the right hand side of Equation 15. In the sleep phase, the objective function is switched by exchanging the places of q_{G} and p_{G} in the KL divergence expression on the left hand side of Equation 15. Then the recognition distribution q_{G} can be trained while fixing p_{G}. The training is performed in an alternating fashion until convergence.

A variational autoencoder takes a different approach. The right hand side of Equation 15 is transformed by the rearrangement shown in Equation 16.

$$\begin{matrix}{〈 log \frac{{q}_{G} ( h \vert d )}{{p}_{G} ( h , d )} 〉}_{{q}_{G} ( h \vert d )} = {〈 log \frac{{q}_{G} ( h \vert d )}{{p}_{G} ( h )} 〉}_{{q}_{G} ( h \vert d )} - \\ {〈 log {p}_{G} ( d \vert h ) 〉}_{{q}_{G} ( h \vert d )} \\ = KL ( {q}_{G} ( h \vert d ) , {p}_{G} ( h ) ) - \\ {〈 log {p}_{G} ( d \vert h ) 〉}_{{q}_{G} ( h \vert d )} .\end{matrix} \qquad Equation 16$$

The variational autoencoder then minimizes the rearranged objective function, which implies minimizing the KL divergence from the approximate posterior q_{G}(h|d) to the prior p_{G}(h) and maximizing the autoencoding term [symbol] log p_{G}(d|h) [symbol] _{q}_{_{G}}_{(h|d)}. A naive autoencoder construction is given by Equation 17 where q_{G}(h|d) and p_{G}(h|d) are built using some probabilistic model.

$$d {\to }^{{q}_{G} ( h \vert d )} h {\to }^{{p}_{G} ( d \vert h )} d \qquad Equation 17$$

The prior distribution p_{G}(h) is trivial distribution such as N(0, I). However, in case where q_{G}(h|d) and p_{G}(d|h) are implemented using probabilistic neural networks, the construction in Equation 17 would not allow for error in the autoencoding term to be directly propagated all the way back to the input layer because evaluating the autoencoding term requires sampling from q_{G} (h|d), which is not deterministic. A strategy to work around this limitation is reparametrization. In this approach q_{G}(h|d) is replaced by using an independent sample ξ from some distribution r(ξ) which is independent of q_{G} and construct a deterministic function F_{q}⁻¹ that takes data d and the independent samples ξ to the latent space h.

Thus far it has been assumed that the latent space h is continuous. In the case of a hybrid quantum-classical variational autoencoder, a quantum computer 301 is used to generate a quantum state 303 from which is obtained samples that are effectively bit strings. This means that certain modification is needed to allow the latent space to be discrete. A separate discrete space 306 z is introduced between the initial data layer 309 and the hidden layer 307: q_{G}(h|d)=q_{G}(z|d)q_{G}(h|z) and p_{G}(h)=q_{G}(h|z)p_{G}(z). Since both q_{G}(h|d) and p_{G}(h) share the component q_{G}(h|z), the KL divergence term in Equation 16 becomes equal to KL(q_{G}(z|d), p_{G}(z)).

The overall hybrid quantum-classical variational autoencoder scheme according to various embodiments is shown in FIG. 3. Here the quantum computer 301 is responsible for generating samples in the discrete latent space 306 for z. The hybrid network is trained by alternating between training the classical and quantum component. In the quantum phase, the quantum circuit is trained to maximize KL(q_{G}(z|d), p_{G}(z)), while keeping the classical network fixed. In the classical phase, the quantum circuit is fixed (and therefore the output distribution of the discrete latent space samples z is also fixed) and the classical network is trained to maximize the objective on the right hand side of Equation 16.

In the special case where the quantum circuit 304 produces an approximate thermal state 303 from some Hamiltonian, there is an efficient method for estimating the gradient components of the training objective as a function of Hamiltonian parameters. However, in the variational autoencoder case, the formalism remains general. The same generality applies to the other hybrid network constructions as well.

In various embodiments, a classical Helmholtz machine is provided. For a given set of data with distribution p(d), possible explanations e∈{0, 1}^{m} are considered. In this setting, d is represented as the input layer of a neural network and e is stored in some hidden layers. The objective is to learn p(d) by training a generative model G that generates n-bit outputs following a distribution p_{G}(d), such that the KL divergence from p_{G} to p is minimized, as in Equation 18.

$$KL ( p ( d ) , {p}_{G} ( d ) ) = {\sum }_{d} p ( d ) log \frac{p ( d )}{{p}_{G} ( d )} \qquad Equation 18$$

Removing the terms that are independent of the generative model, minimizing the KL divergence above is equivalent to minimizing F_{G}(d)=−log p_{G}(d) for every d. The function F_{G}(d) can be rearranged as in Equation 19 where in the last line F_{G} has been rearranged into the form H−TE.

$$\begin{matrix}{F}_{G} ( d ) = - log {p}_{G} ( d ) [ {\sum }_{e} {p}_{G} ( e \vert d ) ] \\ = {\sum }_{e} {p}_{G} ( e \vert d ) log \frac{{p}_{G} ( e , d )}{{p}_{G} ( e \vert d )} \\ = \underbrace{{\sum }_{e} {p}_{G} ( e \vert d ) [ - log ( {p}_{G} ( e \vert d ) ) ]}_{{H}_{G} ( e \vert d )} - \\ \underbrace{{\sum }_{e} {p}_{G} ( e \vert d ) [ - log {p}_{G} ( e , d ) ]}_{{〈 {E}_{G} ( d , e ) 〉}_{G}}\end{matrix} \qquad Equation 19$$

This is the Helmholtz free energy for a physical system of entropy H, energy E and temperature T=1. H_{G}(e|d) is the entropy of the distribution of possible explanations given the data point d and the second term can be interpreted as an average energy. To be more explicit, generative energy may be defined as in Equation 20.

E_{G}(e, d)=−log p_{G}(e, d) Equation 20

For any probability distribution—log p can be regarded as the amount of surprise that the probability p delivers. Zero probability events have infinite surprise and p=1 gives no surprise. Hence, the generative energy can be considered as how surprising a particular combination of data point and explanation is. The conditional probability distribution of explanations with which generative energy is averaged over in Equation 19 is a Boltzmann distribution as in Equation 21.

$${p}_{G} ( e \vert d ) = \frac{exp ( - {E}_{G} ( e , d ) )}{{\sum }_{e} exp ( - {E}_{G} ( e , d ) )} \qquad Equation 21$$

It is generally hard to sample from p_{G}(e|d) and for G that is realized using a feedforward neural network from some latent space x∈{0,1 [symbol] to {0,1}ⁿ, directly minimizing F_{G}(d) using gradient descent is also challenging due to ∇F_{G}(d) not having a structure that can yield insightful gradient algorithm such as backpropagation.

Another model may be introduced that approximates p_{G}(e|d). This is the recognition model and it can be realized by another feedforward network from the data layer 0,1ⁿ to the latent space x∈{0,1 [symbol] . Let p_{R}(e|d) be the distribution that R generates. Because R is introduced to mimic what the generative distribution p_{G}(e|d), the objective is to minimize the KL divergence from p_{R} to p_{G} where the notations for the entropy and average energy are similar to Equation 19, except that the subscript R refers to the recognition model.

$$\begin{matrix}KL ( {p}_{R} ( e \vert d ) , {p}_{G} ( e \vert d ) ) = {\sum }_{e}^{ } {p}_{R} ( e \vert d ) log \frac{{p}_{R} ( e \vert d )}{{p}_{G} ( e \vert d )} \\ = - {H}_{R} ( e \vert d ) + \\ {\sum }_{e}^{ } {p}_{R} ( e \vert d ) ( - log \frac{{p}_{G} ( e , d )}{{p}_{G} ( d )} ) \\ = \underbrace{- {H}_{R} ( e \vert d ) + {〈 {E}_{G} ( e , d ) 〉}_{R}}_{{F}_{GR} ( d )} - {F}_{G} ( d )\end{matrix} \qquad Equation 22$$

The first two terms also take the form of free energy and are grouped into a term F_{GR}(d). Therefore the KL divergence from p_{R} to p_{G} can be written as the difference between two free energy terms. In particular if R is identical to G then F_{GR}(d)=F_{G}(d) For a fixed R, gradient ∇_{G}F_{GR}(d) may be evaluated because H_{R} is independent of G and so [symbol] ∇_{G}E_{G}(e, d) [symbol] _{R} may be evaluated instead, which may be done via local delta rules. Here ∇_{G} represents gradient with respect to parameters of the generative model. Hence F_{GR} may be minimized for a fixed R, and it is useful to do so too. F_{GR} also contains F_{G}, which is the term that ultimately should be minimized, as in Equation 23.

F_{GR}(d)=F_{G}(d)+KL(p_{R}(e|d), p_{G}(e|d)) Equation 23

When minimizing F_{GR} R is driven closer to G while simultaneously minimizing the free energy F_{G}(d). This assumes that there is a good recognition model R. To obtain a good R, a function similar to F_{GR} may be minimized as in Equation 24.

F_{RG}(d)=F_{G}(d)+KL(p_{G}(e|d), p_{R}(e|d)) Equation 24

For a fixed generative model G, F_{GR} may be minimized with respect to R because most of the terms in F_{GR} are independent of R, as shown in Equation 25.

$$\begin{matrix}{F}_{RG} ( d ) = {F}_{G} ( d ) + {\sum }_{e}^{ } {p}_{G} ( e \vert d ) log \frac{{p}_{G} ( e \vert d )}{{p}_{R} ( e \vert d )} \\ = ( G const . ) + {〈 {E}_{R} ( e \vert d ) 〉}_{G} .\end{matrix} \qquad Equation 25$$

Hence ∇_{R}F_{RG}= [symbol] ∇_{R}E_{R}(e|d) [symbol] _{G}, which may also be evaluated by local delta rules.

Thus, the training of a Helmholtz machine in the classical setting consists of two alternating phases: training the generative model G; and training the recognition model R. In the first phase, called the wake phase, the average generative energy is minimized with respect to the recognition distribution [symbol] E_{G}(e, d) [symbol] _{R}. In the second phase, called the sleep phase, the average discriminative energy is minimized with respect to the generative distribution [symbol] E_{R}(e, d) [symbol] _{G}.

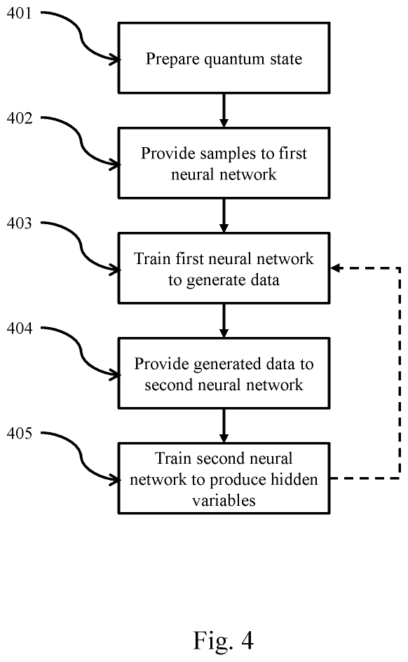

Referring to FIG. 4, a method of operating a Helmholtz machine according to embodiments of the present disclosure is illustrated. At 401, a state is prepared with a quantum circuit. The state corresponds to a probability distribution. In some embodiments, the state is prepared by configuring the quantum circuit according to a plurality of configuration parameters. At 402, a plurality of samples is provided to an input layer of a first neural network by sampling from the state. At 403, the first neural network is trained and the plurality of configuration parameters is tuned to generate data at an output layer of the first neural network, according to the probability distribution. At 404, the generated data are provided to a second neural network. At 405, the second neural network is trained to produce a distribution over variables from the generated data.

As set out above, in various embodiments the training of the Helmholtz machine consists of two phases: a wake phase and a sleep phase. During the wake phase, the generative model is trained. During the sleep phase, the recognition model is trained. The generative model consists of quantum and classical parts and the recognition model is entirely classical. During the wake phase, the parameters for the Hamiltonian used in thermal state generation is tuned by computing the gradient, and the parameters for the classical part of the generative distribution are trained using classical methods. During the sleep phase, the parameters of the recognition network are trained using classical methods.

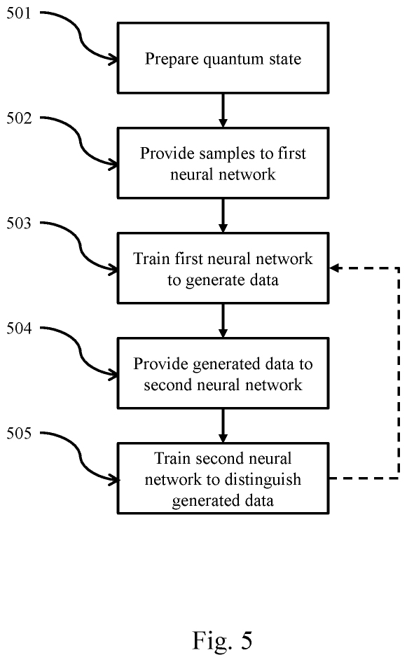

Referring to FIG. 5, a method of operating a generative adversarial network (GAN) according to embodiments of the present disclosure is illustrated. At 501, a state is prepared with a quantum circuit. The state corresponds to a probability distribution. In some embodiments, the state is prepared by configuring the quantum circuit according to a plurality of configuration parameters. At 502, a plurality of samples is provided to an input layer of a first neural network by sampling from the state. At 503, the first neural network is trained and the plurality of configuration parameters are tuned to produce data at an output layer of the first neural network according to the probability distribution. At 504, the data are provided to a second neural network. At 505, the second neural network is trained to distinguish between the generated data and sample data.

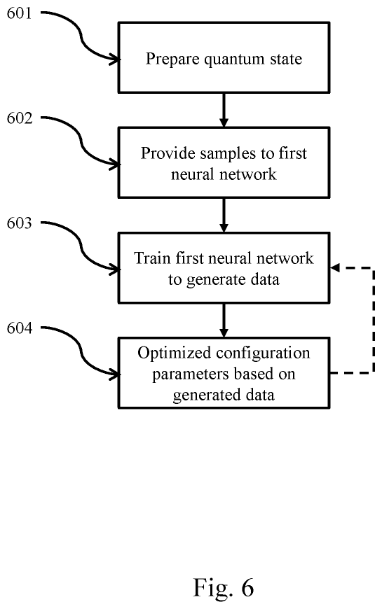

Referring to FIG. 6, a method of operating a variational autoencoder according to embodiments of the present disclosure is illustrated. At 601, a state is prepared with a quantum circuit. The state corresponds to a probability distribution. In some embodiments, the state is prepared by configuring the quantum circuit according to a plurality of configuration parameters. At 602, a plurality of samples is provided to an input layer of a first neural network by sampling from the state. At 603, the first neural network is trained to generate data at an output layer of the first neural network, according to the probability distribution. At 604, the plurality of configuration parameters is tuned based on the generated data.

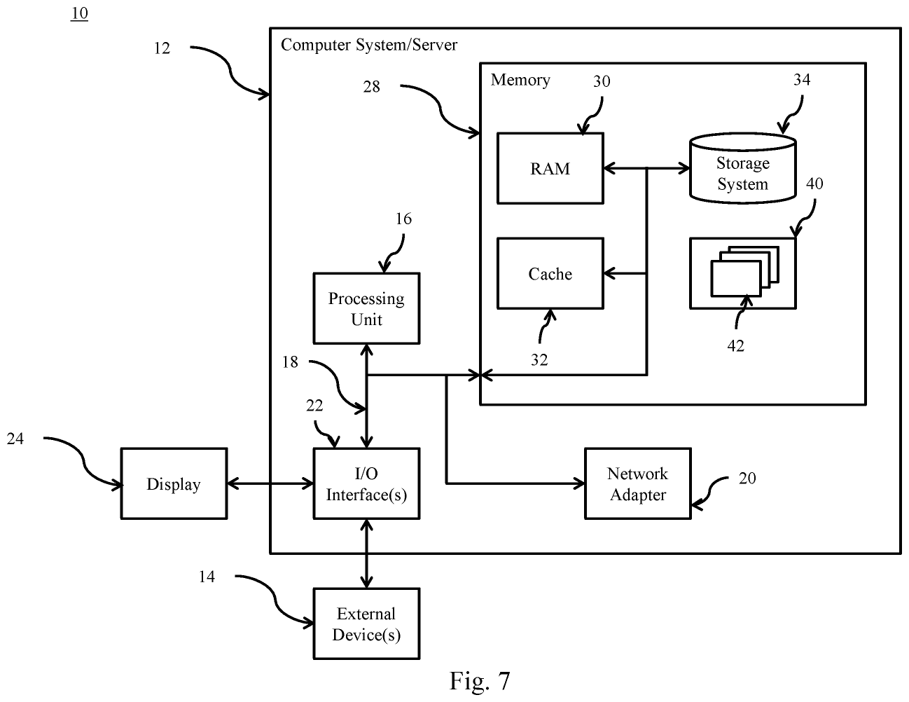

Referring now to FIG. 7, a schematic of an example of a classical computing node is shown. Computing node 10 is only one example of a suitable computing node and is not intended to suggest any limitation as to the scope of use or functionality of embodiments of the disclosure described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 7, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the disclosure as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may include a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
preparing a state with a quantum circuit by configuring the quantum circuit according to a plurality of configuration parameters, the state corresponding to a probability distribution;
sampling from the state to provide a plurality of samples to an input layer of a first neural network;
training the first neural network and tuning the plurality of configuration parameters to generate data at an output layer of the first neural network, according to the probability distribution;
providing the generated data to a second neural network;
training the second neural network to produce a distribution over variables from the generated data.

2. The method of claim 1, wherein the state is a quantum thermal state.

3. The method of claim 1, wherein tuning the plurality of configuration parameters comprises determining a gradient of an objective function.

4. The method of claim 3, wherein tuning the plurality of configuration parameters further comprises performing gradient descent.

5. The method of claim 1, further comprising:
alternating between: 1) training the first neural network and tuning the plurality of configuration parameters; and 2) training the second neural network.

6. The method of claim 1, wherein the first neural network comprises a feedforward neural network, or a Boltzmann machine.

7. The method of claim 1, wherein the second neural network comprises a feedforward neural network or a Boltzmann machine.

8. The method of claim 1, wherein the first neural network comprises at least one hidden layer.

9. The method of claim 1, wherein the second neural network comprises at least one hidden layer.

10. A system comprising:
a quantum circuit;
a computing node comprising a computer readable storage medium having program instructions embodied therewith, the program instructions executable by a processor of the computing node to cause the processor to perform a method comprising:
preparing a state with the quantum circuit by configuring the quantum circuit according to a plurality of configuration parameters, the state corresponding to a probability distribution;
sampling from the state to provide a plurality of samples to an input layer of a first neural network;
training the first neural network and tuning the plurality of configuration parameters to generate data at an output layer of the first neural network, according to the probability distribution;
providing the generated data to a second neural network;
training the second neural network to produce a distribution over variables from the generated data.

11. A method comprising:
preparing a state with a quantum circuit, the state corresponding to a probability distribution;
sampling from the state to provide a plurality of samples to an input layer of a first neural network;
training the first neural network to generate data at an output layer of the first neural network, according to the probability distribution;
providing the generated data to a second neural network;
training the second neural network to produce a distribution over variables from the generated data.

12. The method of claim 11, wherein preparing the state comprises configuring the quantum circuit according to a plurality of configuration parameters.

13. The method of claim 12, wherein preparing the state comprises tuning the plurality of configuration parameters.

14. The method of claim 11, further comprising:
alternately training the first and second neural networks.

15. A system comprising:
a quantum circuit;
a computing node comprising a computer readable storage medium having program instructions embodied therewith, the program instructions executable by a processor of the computing node to cause the processor to perform a method comprising:
preparing a state with the quantum circuit, the state corresponding to a probability distribution;
sampling from the state to provide a plurality of samples to an input layer of a first neural network;
training the first neural network to generate data at an output layer of the first neural network according to the probability distribution;
providing the generated data to a second neural network;
training the second neural network to produce a distribution over variables from the generated data.

16. A method comprising:
preparing a state with a quantum circuit by configuring the quantum circuit according to a plurality of configuration parameters, the state corresponding to a probability distribution;
sampling from the state to provide a plurality of samples to an input layer of a first neural network;
training the first neural network and tuning the plurality of configuration parameters to generate data at an output layer of the first neural network according to the probability distribution;
providing the data to a second neural network;
training the second neural network to distinguish between the generated data and sample data.

17. A system comprising:
a quantum circuit;
a computing node comprising a computer readable storage medium having program instructions embodied therewith, the program instructions executable by a processor of the computing node to cause the processor to perform a method comprising:
preparing a state with the quantum circuit by configuring the quantum circuit according to a plurality of configuration parameters, the state corresponding to a probability distribution;
sampling from the state to provide a plurality of samples to an input layer of a first neural network;
training the first neural network and tuning the plurality of configuration parameters to generated data at an output layer of the first neural network according to the probability distribution;
providing the data to a second neural network;
training the second neural network to distinguish between the generated data and sample data.

18. A method comprising:
preparing a state with a quantum circuit, the state corresponding to a probability distribution;
sampling from the state to provide a plurality of samples to an input layer of a first neural network;
training the first neural network to generate data at an output layer of the first neural network according to the probability distribution;
providing the data to a second neural network;
training the second neural network to distinguish between the generated data and sample data.

19. A system comprising:
a quantum circuit;
a computing node comprising a computer readable storage medium having program instructions embodied therewith, the program instructions executable by a processor of the computing node to cause the processor to perform a method comprising:
preparing a state with the quantum circuit, the state corresponding to a probability distribution;
sampling from the state to provide a plurality of samples to an input layer of a first neural network;
training the first neural network to generate data at an output layer of the first neural network according to the probability distribution;
providing the data to a second neural network;
training the second neural network to distinguish between the generated data and sample data.

20. A method comprising:
preparing a state with a quantum circuit by configuring the quantum circuit according to a plurality of configuration parameters, the state corresponding to a probability distribution;
sampling from the state to provide a plurality of samples to an input layer of a first neural network;
training the first neural network to generate data at an output layer of the first neural network, according to the probability distribution;
tuning the plurality of configuration parameters based on the generated data.

21. The method of claim 20, further comprising:
alternately training the first neural network and tuning the plurality of configuration parameters.

22. A system comprising:
a quantum circuit;
a computing node comprising a computer readable storage medium having program instructions embodied therewith, the program instructions executable by a processor of the computing node to cause the processor to perform a method comprising:
preparing a state with a quantum circuit by configuring the quantum circuit according to a plurality of configuration parameters, the state corresponding to a probability distribution;
sampling from the state to provide a plurality of samples to an input layer of a first neural network;
training the first neural network to generate data at an output layer of the first neural network, according to the probability distribution;
tuning the plurality of configuration parameters based on the generated data.
